(19) United States
(12) Patent Application Publication
(10) Pub. No.: US 2004/0092308 A1
(43) Pub. Date: May 13, 2004

(54) Motion simulation pad

(76) Inventors: Chang Young Lim, Yuseong-gu Taejeon (KR); Min Young Choi, Yuseong-gu Taejeon (KR)

Correspondence Address: PARK & SUTTON LLP, 3255 WILSHIRE BLVD, SUITE 1110, LOS ANGELES, CA, 90010, US

(21) Appl. No.: 10/250,697

(22) PCT Filed: Apr. 26, 2002
(86) PCT No.: PCT/KR02/00771

(30) Foreign Application Priority Data
Aug. 29, 2001 (KR) 2001-52565

(51) Int. Cl. G06F 17/00

(52) U.S. Cl. 463/30

(57) ABSTRACT

Disclosed is a motion simulation pad. More particularly disclosed is a motion simulation pad, which is compact, lightweight, inexpensive and suitable for virtual reality games. The motion simulation pad according to the present invention includes: a lower plate (200); an upper plate (300) disposed above the lower plate (200) in such a manner as to be spaced apart from the top surface of the lower plate (200) via a supporting universal joint (310); a rotating plate (400) rotatively installed on the upper portion of the upper plate (300); and a pair of driving means for transmitting a driving force to two points of the upper plate (300) to allow the upper plate to perform a seesaw/movement by using the supporting universal joint (310) as a seesaw shaft.

### TECHNICAL FIELD

The present invention relates to a motion-simulation pad and, more particularly, to a motion-simulation pad, which is compact, lightweight and inexpensive for virtual reality games. Herein, the term “virtual reality (VR)” refers to a technology that simulates a real situation and makes a user feel that the imaginary experience could be as if it were real. Such a technology has been widely used in various fields including games. There has been well known a simulator using hydraulic, pneumatic or electric motors as a simulator for virtual reality in the fields of games or training course. The present invention is directed to an improved motion-simulation pad that has popular appeal by being made compact, lightweight and inexpensive.

### BACKGROUND ART

In connection with a conventional simulator using hydraulic and pneumatic pressure, there is the motion base device disclosed in Korean Patent Gazette of which Publication Number is 1999-0071426. In construction, the motion base device includes a support plate, an upper plate spaced apart from the top surface of the support plate and having a seat mounted thereon, three hydraulic cylinders interposed between the support plate and the upper plate to form a triangle geometry and adapted to vertically move the upper plate and shake the same and hydraulic pressure exerting means driving hydraulic power to operate three hydraulic cylinders, wherein a first cylinder among three hydraulic cylinders above is fixedly installed on the support plate to be connected to the upper plate and free bending means, and a second cylinder and a third cylinder are respectively connected the support plate to the upper plate via the free bending means.

The hydraulic and pneumatic simulator constructed as above, however, has a drawback of causing big noise and huge pollution besides the fact that it is expensive. For those reasons, the hydraulic and pneumatic simulator has never been manufactured as a motion simulator for households actually. That is, the conventional simulator is disadvantageously impossible to be applied to households or small game rooms since it is of a large-sized booth type and is expensive. Thus, along with the recent wide spread of computers in general houses, although there is a strong need for a compact motion simulator for games, there has not been developed any simulator meeting the need up to now.

A motion simulator using an electric motor has appeared for the purpose of meeting such demands. FIG. 1 shows a motion simulator using electric motors, especially a schematic view illustrating the construction of a three dimensional (3D) simulator for virtual reality disclosed in Korean Utility Model Gazette of which Registration Number is 173399.

The simulator of FIG. 1 includes elevating mechanisms 16 elevated by ball screws which rotate in the right and left directions by servo motors 8 and cylinders 6 in which ball screws are installed in brackets which are respectively mounted on the top surface of a lower support frame 1, a universal joint 17 installed on the upper ends of the elevating mechanisms 16, an upper operation plate 18 fixed to the upper sides of the universal joints 17, and rotating mean 19 (19A, 19B, 19C, 19D, 19E and 19F) disposed on the lower side of the lower support frame 1 which fixes the brackets 2 to rotate a simulator body.

An unexplained reference numeral 5 designates a pulley housing, 25 a capsule, 26 a simulator cover, and 27 a seat.

A driven pulley is installed within the pulley housing 5 and the one side of a belt is connected the driven pulley and the other end of the belt is disposed on a main pulley which is installed on a shaft of the servo motor 8. A ball screw having a right-handed screw part is mounted on the center part of the driven pulley and a carriage having a left-handed screw part within a carriage housing is screwed on the lower end of the ball screw.

FIG. 2 shows another conventional simulator using electric motors, especially a schematic view illustrating the construction of a virtual reality simulator disclosed in Korean Patent Gazette of which Publication Number is 1999-0043649.

In rough description of the construction, the simulator includes a movable plate 120 above a lower support plate 110 in such a manner as to be spaced apart from the top surface of the lower support plate 110, rotary rods 130 (131, 132, 133, 134, 135 and 136) rotatively mounted on the circumferential portion of the movable plate 120, activating elements 150 respectively connected to the rotary rods 130 (131, 132, 133, 134, 135 and 136) at the upper end portion thereof via universal joints 160 on their one end and respectively connected to the lower support plate 110 at the lower end portion via ball joints 170 on their the other end, and driving means 190 for activating the activating elements 150.

Here, the driving means 190 includes a plurality of motors 192 which are mounted on an intermediate support plate 191 disposed to be spaced apart from the top surface of the lower support plate 110, and a lever 194 axially mounted on an output shaft of the motor 192 at one end portion thereof and axially mounted on the central portion of the operation elements 150 at the other end portion thereof. The seat is fixedly mounted on the top surface of the movable plate 120.

Unexplained reference numerals 101 and 102 denote a support plate and a support rod, respectively, and 171 and 172 ball sockets and balls, respectively.

The simulators of FIGS. 1 and 2, however, have a limitation in minimizing the size thereof, and thus they have a difficulty in realizing a compact simulator. They have no rotational or vibration motion either, whereby they have a limitation in meeting the recent needs of various simulation games. Further, they are used as only output means, whereby a user is hard to feel a sense of unity with the simulator. Besides, the simulator of FIG. 1 adopts a triaxial control method using a belt drive and the simulator of FIG. 2 adopts a triaxial control method using a link member, whereby control is difficult to be done. Particularly, the simulator of FIG. 1 is difficult in the entire control of accuracy thereof due to a low accuracy which is a characteristic of the belt drive, and has poor durability due to deterioration of a belt.

### DISCLOSURE OF INVENTION

Accordingly, the present invention is directed to a motion simulation pad that substantially obviates one or more problems due to limitations and disadvantages of the related art.

An object of the present invention is to provide a motion simulation pad suitable for a compact simulator through a structural design that enables the size of a simulator to be minimized.

Another object of the present invention is to provide an inexpensive and compact motion simulation pad having about a notebook size which can be put on a seat or a floor, whereby the motion simulation pad installation and movement and connection with PC or game machines are easily achieved and therefore general people can conveniently enjoy a simulation game, etc. in houses with no need of going to game rooms.

A further object of the present invention is to provide a motion simulation pad capable of creating a dynamic motion in correspondence to a variety of simulation games by allowing the motion simulation pad to perform the rotational and vibration motion.

A still further object of the present invention is to provide a motion simulation pad capable of recognizing a user's movement and using the same as a part of a game configuration by allowing the simulator to function as a bi-directional input/output mechanism.

A yet further object of the present invention is to provide a motion simulation pad capable of achieving easiness in control and superiority in durability by applying a biaxial driving method using a seesaw-movement to the motion simulation pad.

### BRIEF DESCRIPTION OF THE DRAWINGS

Further objects and advantages of the invention can be more fully understood from the following detailed description taken in conjunction with the accompanying drawing in which:

FIG. 1 is a schematic view of a conventional 3D simulator for virtual reality using electric motors (Korean Utility Model Registration No. 173399);

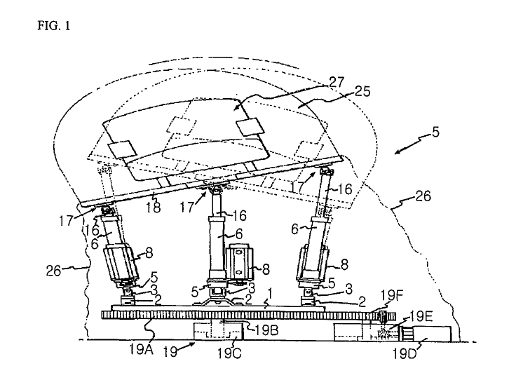

FIG. 2 is a schematic perspective view of another conventional simulator for sensing virtual reality using an electric motor (Korean Patent Publication No. 1999-43649);

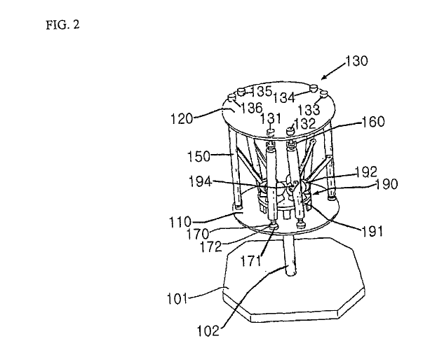

FIG. 3 is an exploded perspective view of a motion simulation pad according to a preferred embodiment of the present invention;

FIG. 4a is a schematic right side view of the motion simulation pad of FIG. 3;

FIG. 4b is an explanatory right side view of the motion simulation pad of FIG. 4a illustrating a dynamics relation between a driving universal joint and a supporting universal joint;

FIG. 5a is a schematic front view of the motion simulation pad of FIG. 3;

FIG. 5b is an explanatory front view of the motion simulation pad of FIG. 5a illustrating a dynamics relation among a motor shaft block, a driving universal joint, and a supporting universal joint; and

FIG. 6 is a schematic plan view of the motion simulation pad of FIG. 3.

### BEST MODE FOR CARRYING OUT THE INVENTION

To achieve these objects and other advantages and in accordance with the purpose of the invention, as embodied and broadly described herein, there is provided a motion simulation pad comprising a lower plate, an upper plate disposed above the lower plate in such a manner as to be spaced apart from the top surface of the lower plate via a supporting universal joint, a rotating plate rotatively installed on the upper portion of the upper plate and a pair of driving means for transmitting a driving force to two points of the upper plate to permit the upper plate to perform a seesaw-movement by using the supporting universal joint as a seesaw shaft.

It is preferable that the driving means includes a screw-type thrust motor fixedly installed on the lower plate and a driving universal joint connected to a reciprocating motor shaft of the thrust motor on an end thereof and connected to the upper plate on the other end thereof to transmit a thrust-movement of the motor shaft to the upper plate so that the upper plate can perform the seesaw-movement.

It goes without saying that various embodiments can be applied instead of the thrust motor. By way of example, a general motor, a pair of bevel gears, and a pair of screw gears can be used in place of the thrust motor. As for a power transmission route, the driving force of the motor installed so as for a motor shaft to be horizontally positioned is transmitted to the driving bevel gear installed on the motor shaft, and then transmitted to the driven bevel gear engaged with the driving bevel gear. Thereafter, the driving force is transmitted to the driving screw gear installed on the driven bevel gear shaft by rotation of the driven bevel gear. Next, the driven screw gear engaged with the driving screw gear performs a reciprocating movement by rotation of the driving screw gear. The reciprocating movement is transmitted to the upper plate by the driving universal joint.

Preferably, a rotation motor may be installed on the upper plate to rotate the rotating plate.

It is preferable that a rotation detector may be installed on the upper plate to detect a rotational movement of the rotating plate.

It is also preferable that the motion simulation pad may include a displacement detector for detecting the amount of displacement of the motor shaft.

It is preferable that a vibration motor may be installed on the upper plate to drive the upper plate. The vibration motor changes the amount of vibration of the motor by using motors having different magnitudes of vibration and provides various vibrations to a user through the combination of vibration motors.

As the detector used in the rotation detection and the displacement detection, a sensor or a switch can be used, and if the sensor is used, either of a non-contact and a contact type can be selected.

The present invention will now be described in detail in connection with preferred embodiments with reference to the accompanying drawings. For reference, like reference characters designate corresponding parts throughout several views.

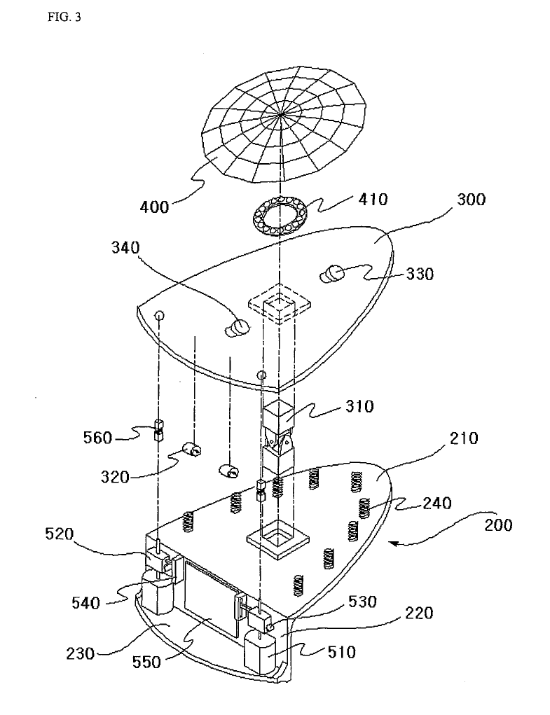

FIG. 3 is an exploded perspective view of a motion simulation pad according to a preferred embodiment of the present invention. As shown in FIG. 3, the motion simulation pad includes a lower plate 200, an upper plate 300, a rotating plate 400, and driving means.

The upper plate 300 is connected to the lower plate 200 by a supporting universal joint 310.

The driving means includes a thrust motor 510 and a driving universal joint 560. The power of the thrust motor 510 is transmitted to the upper plate 300 through the driving universal joint 560. Therefore, the upper plate 300 is constructed to perform a seesaw-movement by an external force through the driving universal joint 560 by using the supporting universal joint 310 as a seesaw shaft. In substitute for the universal joint can be used a ball joint. In contrast to the conventional simulator which makes a 3-axial, a 4-axial, or a 6-axial type motion, the motion simulation pad of FIG. 3 has an advantage of making a corresponding movement with a small force through only a biaxial seesaw-movement.

In the thrust motor 510, a motor shaft screwed with a rotor performs a reciprocating movement by rotation of the rotor, and the reciprocating movement of the motor shaft is transmitted to the upper plate 300 by the driving universal joint 560. At this time, such various motors as an AC/DC motor, a servo motor, a pancake motor, etc. can be used as the motor.

The lower plate 200 is of a double plate shape. The thrust motor 510 is mounted on a lower end plate 230. The thrust motor 510 adopts a screw type, and a motor shaft block 520 is mounted on the reciprocating motor shaft.

A guide roller 530 is mounted in the motor shaft block 520, and guides a smooth reciprocating movement of the motor shaft block 520 by virtue of a rolling movement by a contact with a vertical plate 220 which connects an upper end plate 210 with the lower end plate 230 of the lower plate 200. Further, a displacement detector 540 detects a displacement according to the reciprocating movement of the motor shaft block 520 such that an accurate control is achievable by a feedback control with a game machine. As the displacement detector 540, a variable resistance-type detector can be used, for example. An unexplained reference numeral 550 represents a circuit board.

A spring 240 is installed between the lower plate 200 and the upper plate 300, thereby increasing mechanical durability against vibration as well as making a user feeling a soft operation.

A vibration motor 320 is mounted on the lower portion of the upper plate 300, and a vibration of the vibration motor 320 is transmitted to the rotating plate 400 through the upper plate 300, whereby the user can feel a lively movement through the vibration.

A rotation motor 330 is installed between the upper plate 300 and the rotating plate 400. The rotation motor 330 transmits a rotation through the rotating plate 400 to the user under the control of a game program, for example, such that the user can feel an animated simulation.

A rotation detector 340 is interposed between the upper plate 300 and the rotating plate 400, such that if the user rotates the rotating plate 400, the rotation detector 340 is used as input means toward the game machine. In more detailed description of the rotation detector 340, for instance, when the user sits down on the rotating plate 400 and turns his/her body from side to side, the user's movement is transmitted to the game machine through the rotating plate 400 and the rotation detector 340 and reflected in the games. That is, in case of a flight simulation, a program is configured in such a manner that when the user turns his/her body to the left, a virtual plane simulated on a monitor of the game machine takes a turn to the left.

The rotation motor 330 and the rotation detector 340 are installed so as for the rotary shaft to be horizontally positioned. A roller is mounted on the rotary shaft to output or receive a rotational movement of the rotating plate 400 by performing a rolling movement by a contact with the upper plate 300 and the rotating plate 400 in between the upper plate 300 and the rotating plate 400.

A bearing 410 is installed between the upper plate 300 and the rotating plate 400, and a ball bearing is illustrated in FIG. 3.

The motion simulation pad of FIG. 3 is designed such that a center shaft is moved in two directions within a range of 15°, for example. Through this, the user can feel pitching and rolling in all directions. Additionally, by way of example, the rotating plate 400 capable of rotating in a range of 30° is attached on a seat position, so that a rolling effect can be maximized upon input to the PC/game machine or output to the motion simulation pad.

The motion simulation pad of FIG. 3 is used as a motion base device or a 3D simulator provided to a training simulator, a game simulator and so on. In particular, movements from side to side and front to back, rotation, and vibration are performed in an interconnected manner such that the motion simulation pad is advantageously applicable to virtual amusement games, flight simulators, driving simulators, etc. The present motion simulation pad solves problems of large size, high cost, and big noise which the conventional large hydraulic and pneumatic simulator suffers, and is designed to be simply put on a seat or a floor, thereby increasing applicability to households as a portable simulator. The motion simulation pad of FIG. 3 is easily connected with computers or game machines so as to be used.

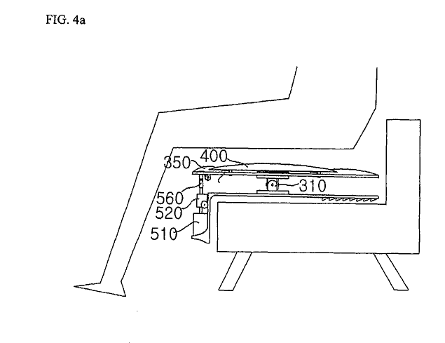

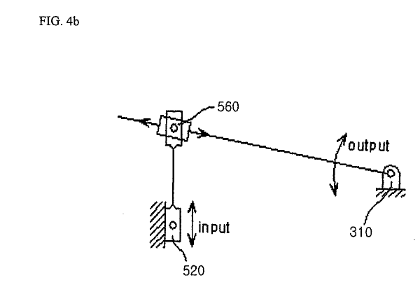

FIG. 4a is a schematic right side view of the motion simulation pad of FIG. 3. As illustrated in FIG. 4a, the motion simulation pad is formed in such a manner that two plates are positioned on the seat at intervals of approximately 3˜4 cm and driving means, such as the thrust motor 510, is disposed in front of the seat. In consequence, there can be ensured a structure and a power transmission method capable of performing a high power with only an output of a small motor.

Of course, the driving means or the like can be inserted into a cushion portion of the seat, thereby constituting a seat for exclusive use of simulation.

The simulation pad of FIG. 4a is used by being connected with a stereophonic surround sound system which is mountable on a backrest or a headrest of a seat, thereby further increasing animated sense. In addition, the motion simulation pad may be connected with head pieces (3D eyeglasses), a driving wheel, a driving pedal, a joystick, a vibration mouse and the like, thereby still more increasing the animated sense.

The motion simulation pad of FIG. 4a is connected to the PC/game machines through a serial communication terminal or a USB communication terminal, and receives a conventional force feedback signal or a motion code of an equipment so as to control the DC thrust motor 510. Also, the motion simulation pad of FIG. 4a directly controls the vertical motor shaft through the aforesaid variable resistance, leading to enhancement in a sensible rate and a reaction rate.

An unexplained reference numeral 350 indicates a cover. The cover serves to protect the motion simulation pad from being damaged due to alien substances.

FIG. 4b is an explanatory right side view of the motion simulation pad of FIG. 4a illustrating a dynamic relation among the motor shaft block 520, the driving universal joint, and the supporting universal joint 310.

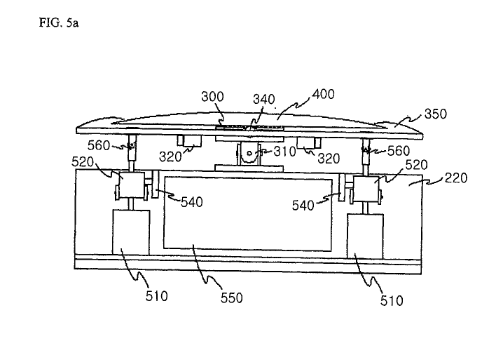

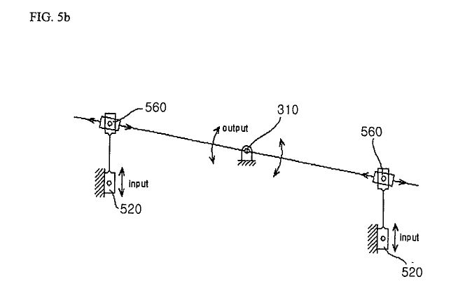

FIG. 5a is a schematic front view of the motion simulation pad of FIG. 3. FIG. 5b is an explanatory front view of the motion simulation pad of FIG. 5a illustrating a dynamic relation among the motor shaft block 520, the driving universal joint 560, and the supporting universal joint 310.

A basic elevating motion in eight directions by the reciprocating movement of the motor shaft caused by the movement of the thrust motor 510 is shown in the following table 1. When the motion simulation pad is viewed from the above, an orientation of the elevating motion is determined such that rear side, front side, left side, and right side correspond to the north, south, east and west, respectively.

TABLE 1

| Position of Left | Position of Right | |
|---|---|---|
| Motor Shaft | Motor Shaft | Descent Orientation |
| Middle | Middle | Horizontal |
| High | High | N |
| Middle | High | NW |
| Low | High | W |
| Low | Middle | SW |
| Low | Low | S |
| Middle | Low | SE |
| High | Low | E |
| High | Middle | NE |

If a signal of the displacement detector 540 suitable for a desired movement other than the basic 8 directional movements is grasped and detected errors are minimized by various feedback control ways, position control and more various directional movements are achievable.

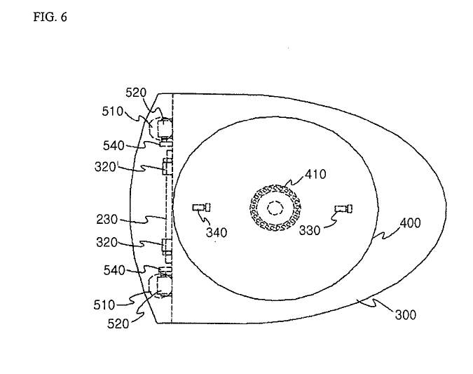

FIG. 6 is a schematic plan view of the motion simulation pad of FIG. 3.

Table 2 is shown for explaining an interaction between the game machine body and the user according to input and output types, in clockwise or counter-clockwise rotation of the rotating plate 400.

| | Direction of | |
|---|---|---|
| Input/Output | Rotation | Action |
| Input | CW | Right, YES, Change |
| | | Menu, etc. |
| | CCW | Left, NO, Select |
| | | Menu, etc. |
| Output | CW | Rotation to the |
| | | Right, Gear up, etc. |
| | CCW | Rotation to the Left, |
| | | Gear Down, etc. |

### INDUSTRIAL APPLICABILITY

As described above, the present invention has an advantage of providing a motion simulation pad suitable for an inexpensive and compact simulator. In addition, the present invention has another advantage of allowing general people to conveniently enjoy simulation games, etc. in houses without going to game rooms.

The present invention has further another advantage of providing a motion simulation pad capable of creating a dynamic motion to conform to a variety of simulation games by performing rotation and vibration functions.

The present invention has still another advantage of letting a simulator recognize a user's movement and using the same as a part of a game configuration by permitting the simulator to function as a bi-directional input/output mechanism.

The present invention has yet another advantage of providing a motion simulation pad having a superiority in durability and achieving easiness in control by adopting a biaxial driving method through a seesaw-movement.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A motion simulation pad comprising: a lower plate; an upper plate disposed above the lower plate in such a manner as to be spaced apart from the top surface of the lower plate via a supporting universal joint; a rotating plate rotatively installed on the upper portion of the upper plate; and a pair of driving means for transmitting a driving force to two points of the upper plate to allow the upper plate to perform a seesaw-movement by using the supporting universal joint as a seesaw shaft.

2. The motion simulation pad of claim 1, wherein the driving means includes: a screw-type thrust motor fixedly installed on the lower plate; and a driving universal joint connected to a reciprocating motor shaft of the thrust motor at one end thereof and connected to the upper plate at the other end thereof to transmit a thrust-movement of the motor shaft to the upper plate and allow the upper plate to perform a seesaw-movement.

3. The motion simulation pad of claim 1 or 2, wherein a rotation motor is installed on the upper plate to rotate the rotating plate.

4. The motion simulation pad of claim 1 or 2, wherein a rotation detector is installed on the upper plate to detect a rotational movement of the rotating plate.

5. The motion simulation pad of claim 1 or 2, further comprising a displacement detector for detecting the amount of displacement of the motor shaft.

6. The motion simulation pad of claim 1 or 2, wherein a vibration motor is installed on the upper plate to vibrate the upper plate.
